(19) United States
(12) Patent Application Publication
(10) Pub. No.: US 2015/0246830 A1
(43) Pub. Date: Sep. 3, 2015

(54) Electrocoagulation System Using Three Phase AC Power

(71) Applicant: Jason D. Lalli, Washington, PA (US)

(72) Inventor: Jason D. Lalli, Washington, PA (US)

(21) Appl. No.: 14/195,034

(22) Filed: Mar. 3, 2014

(51) Int. Cl. C02F 1/463

(52) U.S. Cl. CPC C02F 1/463

(57) ABSTRACT

A system for electrocoagulation is provided that includes a first electrode, a second electrode, and a third electrode, or a plurality thereof. Three phase AC power is provided to the electrodes such that a first phase of the three phase AC power is supplied to the first electrode, a second phase to the second electrode, and a third phase to the third electrode. In some arrangements the three phase AC power has variable frequency and variable voltage. Also provided is an adjustment mechanism that can allow the positioning of each of the electrodes to be adjusted relative to other electrodes in the system.

### FIELD OF THE INVENTION

The present invention relates generally to an electrocoagulation system that employs three phase AC power within a reaction chamber as applied through electrodes to a fluid. More particularly, the present application involves a system that employs three phase AC power that in some embodiments may have variable frequency and variable voltage.

### BACKGROUND

Electrocoagulation is a method that is used to treat a fluid, such as water, that is contaminated with or that otherwise includes another substance. Electrocoagulation historically has used Direct Current (DC) electricity to remove the contaminants and generally utilizes an electrolytic cell that is comprised of an anode and a cathode in its simplest form. Several pairs of metal plates set up in parallel relation to one another can be present in electrocoagulation systems, though other configurations including rods or other shapes are used. A fluid that includes the contaminants is introduced between and contacting the various plates. The plates are generally made of a material such as iron or aluminum that allow for the production of ions in the fluid when electricity is applied to the plates, though other metals may also be used.

In electrocoagulation, reactions occur on the cathodes and anodes when electricity is applied. Ions are released during these reactions and interact with the contaminants in the fluid to remove them by precipitation or by causing them to coalesce. The contaminants may be removed through other mechanisms and reactions during electrocoagulation in that the charged state of the fluid induces a separation between the fluid and the contaminant(s) within the fluid.

During electrocoagulation a build-up of byproducts on the electrodes may occur thus requiring increased power be delivered to the metal plates to achieve the same level of contaminant removal. One way to remove this build-up on the plates is to reverse the polarity of the plates. Mechanical switches can be used to switch the polarity of the first plate from an anode to a cathode, and likewise cause the second plate to be changed from a cathode to an anode. These mechanical switches are used when the electricity supplied to the plates is DC current. Although capable of achieving the desired purpose of cleaning the plates, such switching must be done on a frequent basis (for example once every ten seconds) and these switching mechanisms are subject to failure.

One alternative used in electrocoagulation systems that removes the necessity of the switching mechanisms is the use of single phase AC power instead of DC power to drive the reactions. With AC power, the polarity of the plates is naturally reversed several times every second thus minimizing the build-up of material on the plates. Although capable of reducing the build-up on the electrodes, the use of AC power can be less efficient than the use of DC power in electrocoagulation systems and is therefore associated with higher energy costs of running the system. As such, there remains room for variation and improvement within the art: the application of three phase AC power to the electrodes allows for natural polarity switching at the electrodes, while overcoming the inefficiencies of single phase AC power.

### BRIEF DESCRIPTION OF THE DRAWINGS

A full and enabling disclosure of the present invention, including the best mode thereof, directed to one of ordinary skill in the aft, is set forth more particularly in the remainder of the specification, which makes reference to the appended Figs. in which:

FIG. 1 is a schematic view of an electrocoagulation system that supplies three phase AC power to electrodes.

FIG. 2 is a schematic view of an electrocoagulation system that has a generator that produces three phase AC power that has variable voltage and variable frequency.

FIG. 3 is a schematic view of an electrocoagulation system that has a variable frequency drive capable of adjusting both voltage and frequency of 3 phase AC power supplied to the electrodes.

FIG. 4 is a schematic view of an electrocoagulation system that has four electrical stages after a power supply.

FIG. 5 is a schematic view of an electrocoagulation system that as two electrical stages after a power supply.

FIG. 6 is a perspective view of an electrocoagulation system in accordance with one exemplary embodiment.

FIG. 7 is a top view of the electrocoagulation system of FIG. 6.

FIG. 8 is a front view of the electrocoagulation system of FIG. 6.

FIG. 9 is a side view, with a panel removed for clarity, of an electrocoagulation system in accordance with an alternative exemplary embodiment.

FIG. 10 is a front view taken along line 10-10 of FIG. 9.

FIG. 11 is a front view taken along line 11-11 of FIG. 9.

FIG. 12 is a perspective view of a chamber for an electrocoagulation system that is a pressurized chamber in accordance with another exemplary embodiment.

FIG. 13 is a front view of a pressurized electrocoagulation chamber in accordance with another exemplary embodiment.

FIG. 14 is a perspective view of a plate arrangement of the pressurized electrocoagulation chamber of FIG. 12.

FIG. 15 is an exploded perspective view of a detailed section of the plate arrangement showing an adjustable mechanism.

FIG. 16 is a detailed perspective view of a section of plates showing their positional relationship with one another.

FIG. 17 is a top view of a plate and post of the embodiment of FIG. 15.

FIG. 18 is a front view of the plate arrangement with an alternative adjustment mechanism.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for an electrocoagulation system 10 that may be used to separate substances from one another. For example, the electrocoagulation system 10 may be used to separate water from contaminants in a fluid 26 that may be hydraulic fracturing flow back fluid. The system 10 employs three phase AC power and supplies same to a first electrode 12, second electrode 14, and third electrode 16 over which the fluid 26 may pass. In its broadest sense, the system 10 is a three phase alternating current electrocoagulation system 10. Each phase of the three phase AC power can be supplied to one of the electrodes 12, 14 and 16 and the contaminants are removed from the fluid 26 when the electrodes 12, 14 and 16 are energized. In certain applications, the frequency and/or voltage of the three phase AC power supplied to the electrodes 12, 14 and 16 may be variable. Also, in other arrangements, the electrodes 12, 14 and 16 may be arranged as plates with apertures 28, 30 and 32 through which the fluid 26 may pass during separation. However, it is to be understood that the system 10 need not have variable voltage, variable frequency, or have plates with apertures 28, 30, 32 through which fluid passes in accordance with other embodiments. For example, the system 10 may only include three phase AC electrocoagulation without the aforementioned variations and features.

The use of three phase AC power may allow for work to be performed more efficiently than if single phase AC were employed in the system 10. As such, three phase AC power used in the electrocoagulation system 10 may require less energy to do the same amount of electrocoagulation than the case in which single phase AC power is used. Further, the use of three phase AC power may eliminate mechanical switches that are used to change the polarity of the electrodes 12, 14 and 16 as used in DC powered electrocoagulation because the AC power naturally changes polarity in the electrodes 12, 14 and 16 without the need for mechanical switches due to the reversal of polarity inherent in alternating current. Still further, the use of three phase AC power may allow for work to be done comparable to or more efficiently than if DC power were used, thus allowing for the electrocoagulation system 10 run by three phase AC power to require less energy than one run by DC power to achieve the same amount of electrocoagulation.

During use of the system 10, the voltage and/or frequency of the three phase AC current applied to the electrodes 12, 14 and 16 may be adjusted in order to optimize or better control the reaction that is taking place. The electrocoagulation system 10 may be more efficiently run if the voltage and/or frequency of the three phase AC current is adjusted during the electrocoagulation process of removing contaminants from the fluid 26 after starting the process of removing the contaminants from the fluid 26. The first electrode 12 may be supplied with the first phase 18, the second electrode 14 is supplied with the second phase 20, and the third phase 22 may be supplied to the third electrode 16.

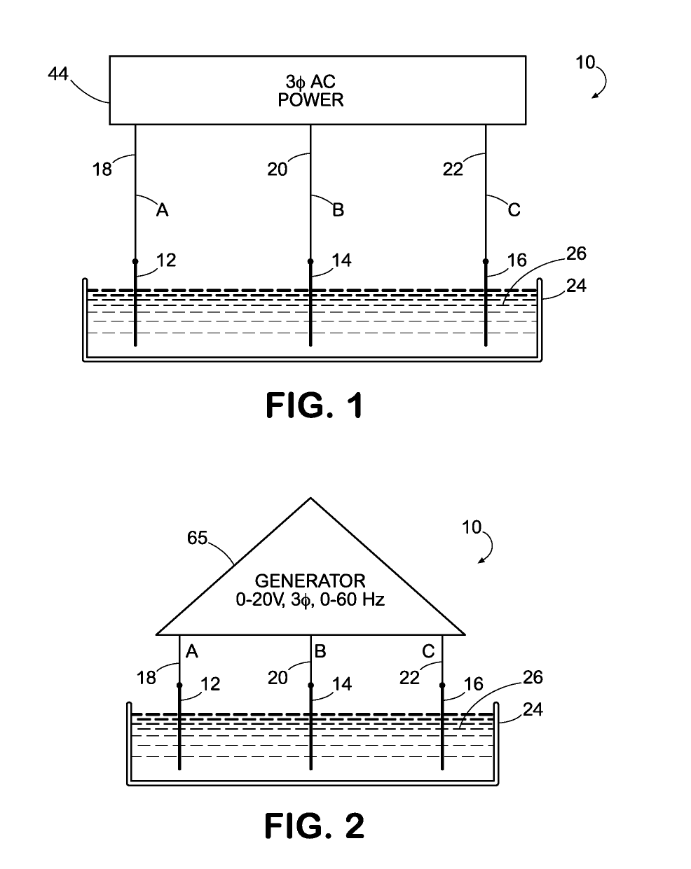

One exemplary embodiment of the electrocoagulation system 10 is illustrated with reference to FIG. 1. The electrodes 12, 14 and 16 are located within a chamber 24 that also houses fluid 26 that is to be treated in the electrocoagulation process. The electrodes 12, 14 and 16 may be bars, plates, or variously shaped. The electrodes 12, 14 and 16 may be shaped the same as one another or one or more of them may be shaped or sized differently than the other(s). The three phase AC power that is supplied to the electrodes 12, 14 and 16 can be supplied in a variety of ways, and it is to be understood that the manner of supplying the three phase AC power illustrated in FIG. 1 is but one exemplary embodiment. A power supply 44 provides three phase AC power to the electrodes 12, 14 and 16. The first phase 18, the second phase 20 and the third phase 22 extend from the power supply 44 in separate lines. A neutral line may also be present, but may not be shown for sake of clarity. As such, various neutral “N” lines may be present in the system 10 but are not shown in the drawings or described in the specification for sake of clarity. As used in the figures and present specification, the first phase 18 may be identified as the letter “A”, the second phase 20 may be identified as the letter “B”, and the third phase 22 may be identified as the letter “C.” These designations are used simply to better explain the structure and functioning of the electrocoagulation system 10.

The three phase AC power can be supplied to the electrodes 12, 14 and 16 and electrocoagulation of the fluid 26 can occur such that contaminants or other objects in the fluid 26 are separated from the fluid 26. Switching polarity of the electrodes 12, 14 and 16 by way of the natural characteristics of alternating current may be done so that side reactions on the electrodes 12, 14 and 16 can take place. The polarity change may reverse the current flow and knock chemical by-products from the electrodes 12, 14 and 16 and restart the electrocoagulation process on the opposite sides of the electrodes 12, 14 and 16.

The three phase AC power is shown coming from power supply 44. The three phase AC power may come directly from an energy provider and input into the electrodes 12, 14, and 16. Alternatively, any number of electrical components can be disposed between the three phase AC power source and the electrodes 12, 14 and 16. The power supply 44 is disclosed simply as a representation of a source of three phase AC power that is provided to the electrodes 12, 14 and 16 and this source can come from any number of devices. The three phase AC power can have any voltage and frequency. In some arrangements, the three phase AC power supplied is 460 volts and 60 hertz.

One way of configuring the system 10 is illustrated with reference to FIG. 2. Here, a generator 66 generates three phase AC power and the first phase 18 is directed into the first electrode 12, the second phase 20 is directed into the second electrode 14, and the third phase 22 is directed into the third electrode 16. The generator 66 itself functions to produce the three phase AC power, and may be thought of as being the power supply 44 as previously discussed. The three phase AC power that is generated may be capable of being varied by the user of the system 10 such that the voltage and frequency are variable. The voltage supplied to the electrodes 12, 14 and 16 may be capable of being varied from 0-20 volts, and the frequency of the phases 18, 20 and 22 supplied to the electrodes 12, 14 and 16 may be capable of being varied from 0-60 hertz. The frequency and voltage need not be capable of being varied by the generator 66 in accordance with other embodiments.

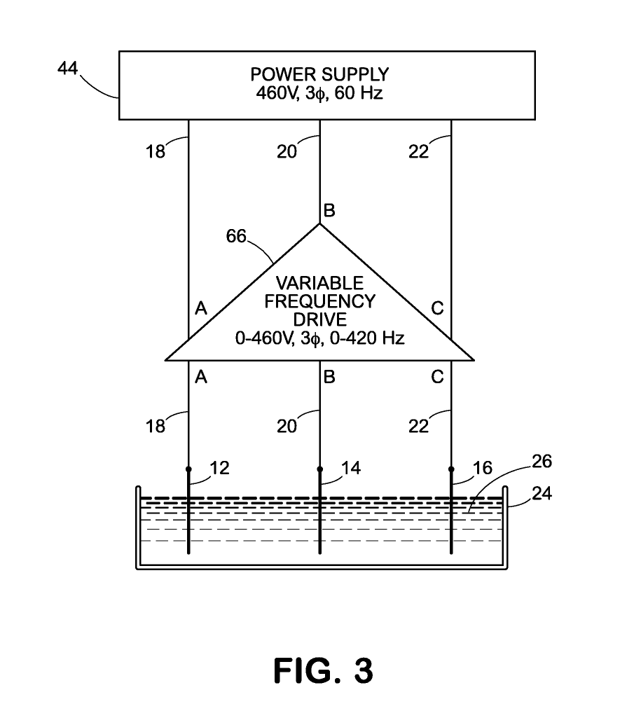

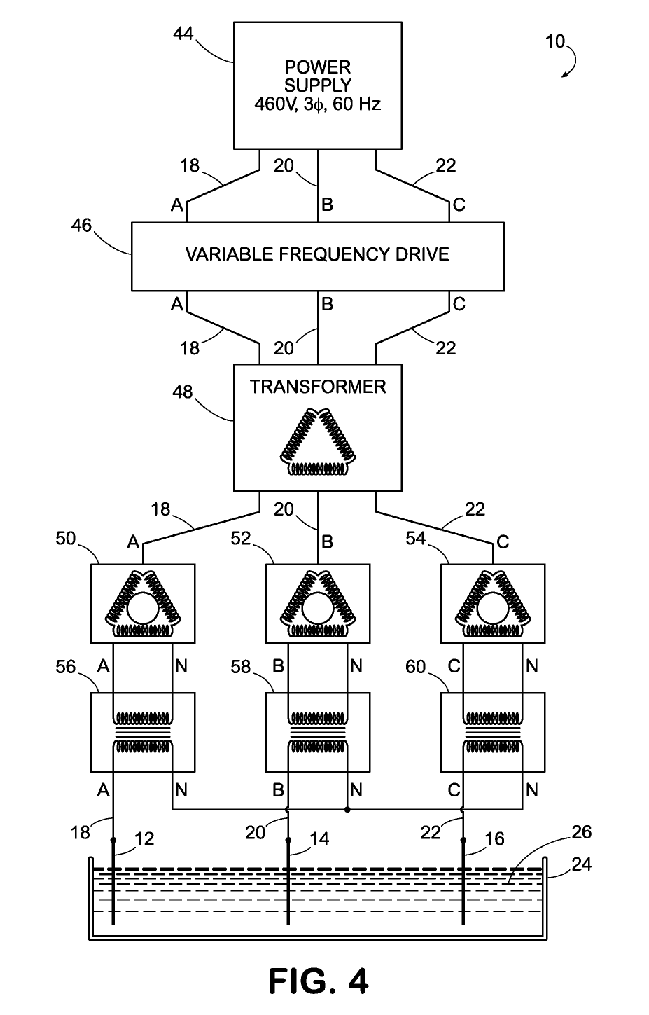

Another arrangement of the system 10 is illustrated with reference to FIG. 3 in which a power supply 44 provides three phase AC power at 460 volts and 60 hertz. The power supply 44 may be, for example, a generator 65 or can be power that is supplied from a power company through their transmission lines. The three phases 18, 20, 22 are directed to a variable frequency drive 66. The variable frequency drive 66 is capable of varying the voltage of the three phase AC power such that it may be varied from 0-460 volts. Also, the variable frequency drive 66 may be capable of varying the frequency of the three phase AC power from 0-420 hertz. As such, the variable frequency drive 66 allows for the varying of both voltage and frequency. The power output to the electrodes 12, 14 and 16 may be three phase AC power with adjustable voltage from 0-460 volts and adjustable frequency from 0-60 hertz. The first phase 18 is supplied to the first electrode 12, the second phase 20 is supplied to the second electrode 14, and the third phase 22 is supplied to the third electrode 16. The electrocoagulation system 10 may be run in the same manner as previously discussed in order to remove contaminants from the fluid 26. The variable frequency drive 66 may be a POWERFLEX® 700 series AC drive under the brand of Allen-Bradley provided by Rockwell Automation having offices located at 1201 S 2nd St, Milwaukee, Wis. 53204, USA. Another arrangement of the system 10 is shown with reference to FIG. 4.

A power supply 44 is provided and generates/supplies 460 volt, three phase, 60 hertz AC power. The 460 volt may be the voltage on the individual legs, and the voltage to ground may be 277 volts. The first phase 18, the second phase 20 and the third phase 22 exit the power supply 44 in separate lines. The three phases 18, 20 and 22 may next be input into a variable frequency drive 46. The variable frequency drive 46 may be a device that functions to allow the frequency of the input power to be adjusted. The variable frequency drive 46 is a bit different than the variable frequency drive 66 discussed in regards to the FIG. 3 embodiment in that the variable frequency drive 46 may not be capable of varying the voltage but only capable of varying the frequency. The variable frequency drive 46 may cause the frequency to be adjusted such that the power exiting the variable frequency drive 46 is 460 volt, three phase AC power that has an adjustable frequency from 0-60 hertz. This power is 460 volts to the other legs, but is 277 volts to the ground at this point in the system 10.

The system 10 also includes a transformer 48 into which the power exiting the variable frequency drive 46 is input. The transformer 48 functions to reduce the voltage of the power entering the transformer 48. The power exiting the transformer 48 is at 208 volts, three phase AC power that has an adjustable frequency from 0-60 hertz. The voltage is 208 volts to the other legs, but is 120 volts to the ground. The legs can be tied separately to the ground at the point after exiting the transformer 48 and thus each leg may now be described as having a voltage of 120 volts.

The first phase 18 exits the transformer 48 and is input into a first variable transformer 50. The first variable transformer 50 is a device that functions to cause the voltage of the input power to be adjustable. The first phase 18 enters as 120 volts to ground AC power with adjustable frequency from 0-60 hertz, and exits the first variable transformer 50 as AC power with adjustable voltage from 0-120 volts and adjustable frequency from 0-60 hertz.

A second variable transformer 52 is included in the system 10 and receives the second phase 20 that exits the transformer 48. The second variable transformer 52 functions to cause the voltage of the power input to be adjustable. The second phase 20 exits the second variable transformer 52 as AC power that has an adjustable voltage from 0-120 volts and an adjustable frequency that is from 0-60 hertz. A third variable transformer 54 is likewise included and receives the third phase 22 from the transformer 48 and operates to cause the voltage of the third phase 22 to be adjustable from 0-120 volts. As such, the third phase 22 exiting the third variable transformer 54 is adjustable from 0-120 volts, AC power that has a frequency that is adjustable from 0-60 hertz.

Three step down transformers 56, 58 and 60 are included and each one receives one of the phases 18, 20 or 22 exiting the variable transformers 50, 52 and 54. The first step down transformer 56 receives the output from the first variable transformer 50 and functions to reduce the voltage of the first phase 18 by a factor of five. As such, the first phase 18 exits the first step down transformer 56 as AC power having an adjustable voltage from 0-20 volts and an adjustable frequency from 0-60 hertz. The first variable transformer 50 and the first step down transformer 56 show a neutral line “N.” It is to be understood, however, that other neutral lines may exist in the system 10 but are not shown for sake of clarity in the figures and description. The first phase 18 exiting the first step down transformer 56 is input into the first electrode 12 that is in the chamber 24 and engages the fluid 26.

The second step down transformer 58 receives the second phase 20 and functions to step down the voltage by a factor of five. The power leaving the second step down transformer 58 is AC power with an adjustable voltage of 0-20 volts and an adjustable frequency of 0-60 hertz. The neutral line “N” is tied into the neutral line “N” exiting the first step down transformer 56. The second phase 20 that exits the second step down transformer 58 is input into the second electrode 14 of the chamber 24. The third step down transformer 60 receives the third phase 22 output from the third variable transformer 54 and reduces the voltage by a factor of five so that the third phase 22 exiting the third step down transformer 60 is AC power adjustable from 0-20 volts and from 0-60 hertz. This third phase 22 is then sent to the third electrode 16 in the chamber 24. Although the lines are connected directly, a bus bar system may be employed to deliver the electricity to the electrodes 12, 14 and 16. Further, additional electrodes can be included in the chamber 24 in other embodiments and may receive the three phases 18, 20 and 22.

Although described as being adjustable from 0-20 volts, it is to be understood that this number may not be exact as power supplied from the power supply 44 may not necessarily be exactly at 460 volts. As such, the voltage may be adjustable from 0-24 volts in some arrangements. It may be the case that power is supplied at voltages and frequencies that are not exactly as advertised by the provider. Likewise the frequency may not be exactly adjustable from 0-60 hertz but can be some adjustable range close to this range. It is to be understood that some factor of error may be present in the stated numbers and that they are only for sake of example.

The power supplied to the electrodes 12, 14 and 16 is thus three phase AC power having adjustable voltage from 0-20 volts and adjustable frequency from 0-60 hertz. The various electrical components in the system 10 of FIG. 4 function simply to cause the power input into the electrocoagulation process to be three phase AC power with adjustable voltage and adjustable frequency. The various electrical components may be switched out with other components in previously discussed systems 10.

The use of three phase AC power in electrocoagulation functions to cause contaminants or other objects to be separated from the fluid 26. The arrangements that have the ability to adjust the frequency of the power supplied to the electrodes 12, 14 and 16 can allow the positive and negative charges of the electrodes 12, 14 and 16 to be adjusted as desired. It may be desired to vary the duration of this positive to negative adjustment to a longer time scale, for example from once a second to once every thirty seconds, to control the types of reactions happening in the system 10. The polarity of the electrodes 12, 14 and 16 may be changed once every ten seconds in certain exemplary embodiments in order to mimic the reactions that take place in standard DC-powered electrocoagulation reactors with automatic polarity switch mechanisms.

The voltage of the electrodes 12, 14 and 16 may be adjusted in order to control the type of work being performed. The electrodes 12, 14 and 16 may be made of a variety of materials such as aluminum, iron or titanium. All of the electrodes 12, 14 and 16 may be made of the same material, or certain electrodes 12, 14 and 16 may be made of one material while another one or ones are made of different materials. The type of material making up the amount of voltage applied to the electrodes 12, 14 and 16. At low voltages, the electrodes 12, 14 and 16 may not participate in the electro-chemical reactions and instead may function as true catalysts. As the voltage to the electrodes 12, 14 and 16 is increased the type of reaction that is occurring may be changed. At a certain point of voltage increase, the “pitting potential” of the metal may be exceeded and the metal itself may participate in the reaction and the system may change over to electrocoagulation. It is to be understood that as used herein, the term “electrocoagulation” is broad enough to cover systems 10 that can run electrocoagulation, can run as a catalyst, or can run as some hybrid of the two, or can run any one of or all combinations of the aforementioned.

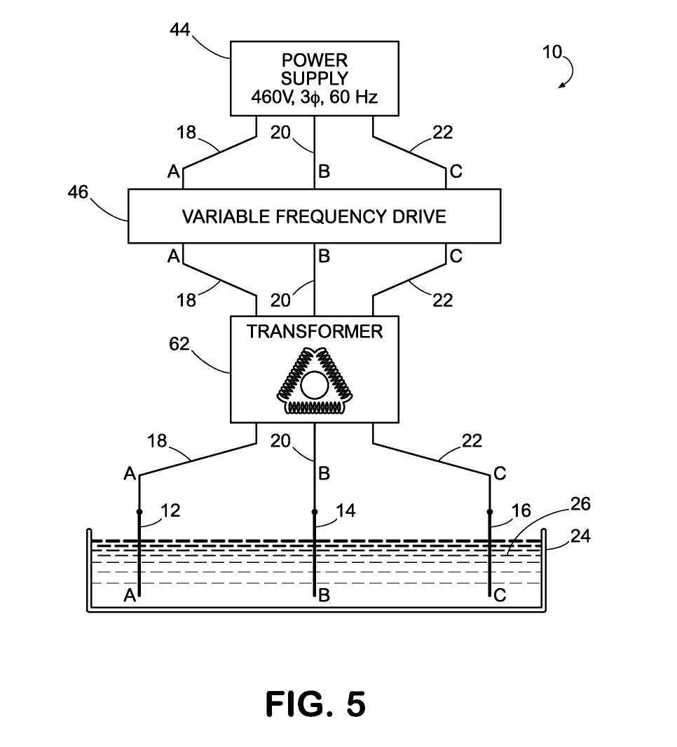

As discussed, the components of the system 10 can be varied in order to supply power to the electrodes 12, 14 and 16 in a variety of manners. FIG. 5 shows yet another such variation in which three phase AC power at 460 volts with a frequency of 60 hertz is supplied by a power supply 44. A variable frequency drive 46 receives the output from power supply 44 and causes the power exiting the variable frequency drive 46 to be 460 volt three phase AC power with an adjustable frequency from 0-60 hertz. This arrangement is the same as that previously discussed with respect to FIG. 4. However, at this point, the output from the variable frequency drive 46 is input into a variable transformer 62 that receives all three phases 18, 20 and 22. The variable transformer 62 functions to cause the voltage of the power to be adjustable such that the power leaving the variable transformer 62 is three phase AC power with an adjustable voltage from 0-460 volts and an adjustable frequency from 0-60 hertz. The first phase 18 is transferred to the first electrode 12, the second phase 20 to the second electrode 14, and the third phase 22 to the third electrode 16. The electrodes 12, 14 and 16 may be charged in a manner similar to those embodiments previously discussed to run the electrocoagulation process as the power supplied to the electrodes 12, 14 and 16 is the same and the configuration of the electrodes 12, 14 and 16 may be the same. The only difference between the embodiments in FIGS. 5 and 4 is the electrical components used to modify the power from the power supply 44.

The variable frequency drive 66 of FIG. 3 may be used in any of the previously described embodiments. The variable frequency drive 66 may be substituted the variable frequency drive 46 of FIG. 4. In this alternative arrangement, the three phase AC power may be manipulated by the variable frequency drive 66 to have its frequency and voltage adjusted. In another embodiment, the variable frequency drive 66 described with reference to FIG. 3 can be incorporated into the design described with reference to FIG. 2 such that the variable frequency drive 46 is replaced with the variable frequency drive 66. In this arrangement, the variable frequency drive 66 may cause the voltage and frequency to be adjusted before being sent to the transformer 62. Various parts from any of the described embodiments can be incorporated into other described embodiments to yield differently configured systems 10.

A sinusoidal filter can be in included in the system 10. The sinusoidal filter can be incorporated into, for example, the variable frequency drive 66, the variable frequency drive 46, or the generator 65. The sinusoidal filter, alternatively, may be located just after the variable frequency drive 66, the variable frequency drive 46, or the generator 65 such that the three phases 18, 20 and 22 exits one of these devices 66, 46, or 65 and then enters the sinusoidal filter. Still further, the sinusoidal filter may be located anywhere else in the system 10 in other exemplary embodiments. The sinusoidal filter may function to clean up the sine wave of the AC power so that the sine wave present at the device 66, 46, or 65 is more smooth than without the presence of the sinusoidal filter. This filtering may cause the device 66, 46, or 65 to run more smoothly with less noise and with greater efficiency. The sinusoidal filter need not be present in the system 10 in other exemplary embodiments.

Although described as being variable voltage and variable frequency, it is to be understood that the three phase AC power supplied to the electrodes 12, 14 and 16 need not be both variable voltage and variable frequency, but may be of consistent, non-variable voltage, or may be of consistent, non-variable frequency in certain exemplary embodiments. Also, although a voltage range of 0-20 volts or 0-460 volts has been discussed, it is to be understood that this voltage range is only exemplary and that others are possible. For example, the voltage may be adjustable from a range of 0-500 volts, from 0-1000 volts, or up to 1500 volts in accordance with certain exemplary embodiments. Further, although a frequency range of 0-60 hertz has been discussed, it is to be understood that this range is only for sake of example and that others are possible. For instance, the frequency may be adjustable from 0-80 hertz, from 50-100 hertz, or up to 300 hertz in accordance with certain exemplary embodiments.

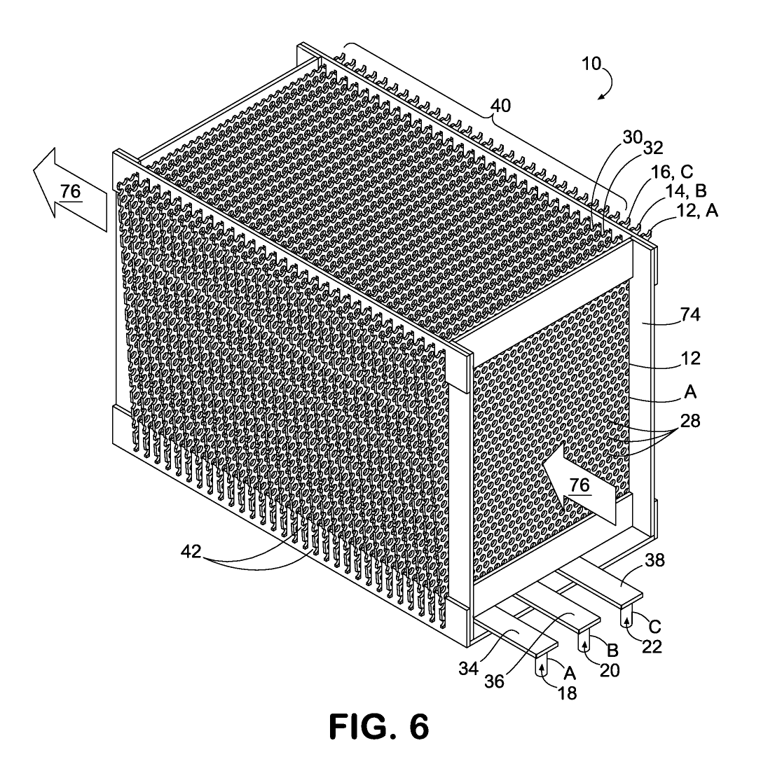

The electrodes 12, 14 and 16 may be provided in the shape of plates. FIGS. 6-8 disclose an arrangement of the system 10 in which the electrodes 12, 14 and 16 are plates that have a trapezoidal shape. In other arrangements, the electrodes 12, 14 and 16 may be plates that have square, rectangular, or circular shapes. The electrodes 12, 14 and 16 may all be of the same size and shape, or they may be of different sizes and shapes. The first electrode 12 has a plurality of apertures 28 that extend therethrough. The apertures 28 may be sized the same as one another and can be evenly spaced about the first electrode 12. The second electrode 14 can be a plate and may be spaced a distance from the first electrode 12 so that they do not touch one another. The second electrode 14 may have a series of apertures 30 that extend therethrough. The apertures 30 may be of the same size and shape as one another and may be evenly spaced about the surface of the second electrode 14. The apertures 30 may haves axes that are parallel with or that are coaxial and parallel with the axes of the apertures 28 of the first electrode 12.

A third electrode 16 may be included in the system 10 and can include a plurality of apertures 32 that extend therethrough. The apertures 32 may be all of the same size and shape as one another and can be evenly spaced about the third electrode 16. The third electrode 16 can be spaced from the second electrode 14 such that it does not touch the second electrode 14. The second electrode 14 may thus be located between the first and third electrodes 12 and 16. The apertures 32 may have axes that are parallel with, or that are both parallel and coaxial with, the axes of the apertures 28 and 30.

A series of additional electrodes 40 can be arranged subsequent to the third electrode 16 and may be configured as plates that are spaced a distance from the third electrode 16 and from one another. The spacing between all of the plates 12, 14, 16 and 40 may be the same as one another. Apertures 42 may extend through all of the additional plates 40 and can be sized and shaped the same way and may cover the same area of the additional plates 40. The apertures 42 may be parallel or coaxial and parallel with the various apertures 28, 30 and 32. There may be any number of additional plates 40 in accordance with various exemplary embodiments. For example, from 3-30 additional plates may be present. The additional plates 40 may be of a number that is wholly divisible by three in certain arrangements. The additional plates 40 may be trapezoidal in shape and may be sized and shaped identically to the electrodes 12, 14 and 16. However, in other arrangements, one or more of the additional plates 40 may be sized or shaped different from one another, or different from one of the electrodes 12, 14 and 16. All of the electrodes 12, 14, 16 and 40 may be configured in shape, material, size, and with other properties in accordance with any of the embodiments discussed herein.

The various electrodes 12, 14, 16 and 40 may be held within a frame 74. The frame 74 is shown in an open configuration in FIGS. 6-8 for purposes of clarity, but it is to be understood that flat panels and other members may be included with the frame 74 in order to form the chamber 24 to contain the fluid 26. A direction of fluid flow 76 is illustrated as extending through all of the plates by first engaging in successive order the first electrode 12, second electrode 14, third electrode 16 and last the additional electrodes 40. The various apertures 28, 30, 32 and 42 can be aligned/coaxial with one another or may be offset from one another. The fluid 26 may thus flow through the plates 12, 14, 16, 40 and not around, under, or over.

The frame 74 may define a conduit 72 that is located under the chamber 24 that holds the various electrodes 12, 14, 16 and 40. The conduit may be an empty space that runs under the various electrodes 12, 14, 16 and 40 that is separated from them and that does not directly face them. Fluid 26 may not flow through the conduit 72, and the conduit 72 may be in fluid isolation from the chamber 24. A plurality of bus bars 34, 36 and 38 may extend through the conduit 72 and can be used to place the various electrodes 12, 14, 16 and 40 into electrical communication with the power sent from the power supply 44, variable frequency drive 66, step down transformers 56, 58, 60, variable transformer 62, or other component of the system 10.

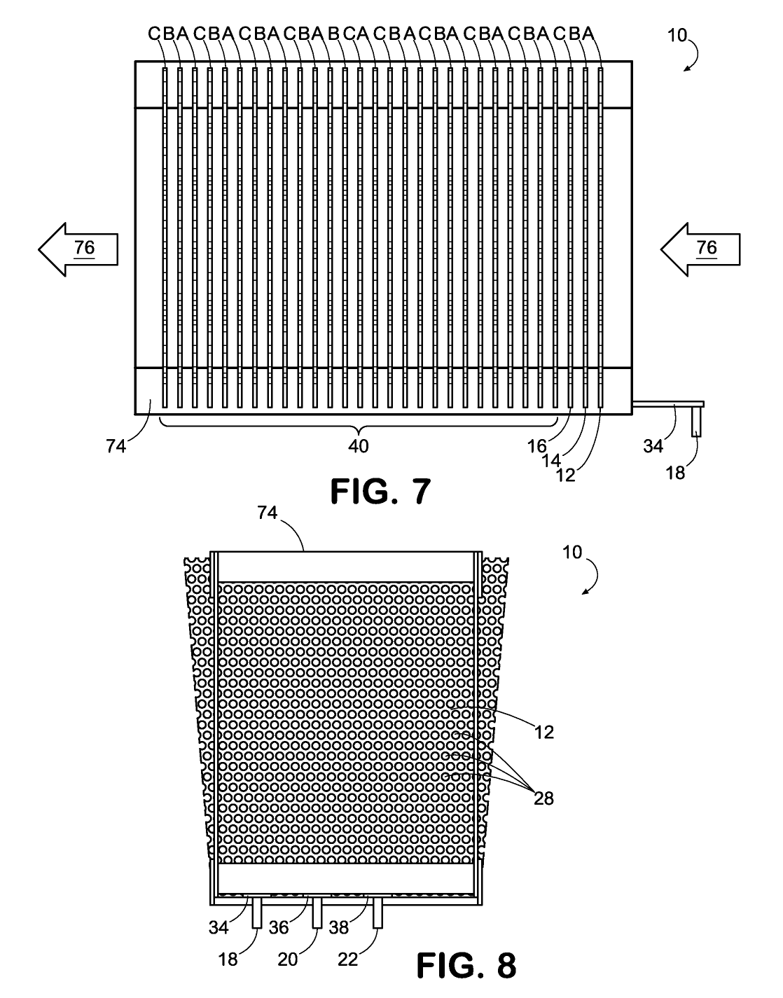

The first phase 18 can be transferred through the first bus bar 34. The first bus bar 34 is in electrical communication with the first electrode 12 so that the first phase 18 is transferred through the first bus bar 34 and into the first electrode 12. The first bus bar 34 may be placed into electrical communication with the first electrode 12 through any electrical attachment, or may be in direct contact in certain exemplary embodiments. The first phase 18 is labeled with the letter “A” and as shown in FIG. 7 the first phase 18 A may be supplied to certain ones of the additional electrodes 40. These additional electrodes 40 are in electrical communication with the first bus bar 34 by either electrical attachments or through direct contact.

The second phase 20 is transferred through the second bus bar 36 and into the second electrode 14. The second bus bar 36 is in electrical communication with the second electrode 14 via any mechanism such as direct engagement or electrical connection. The second phase 20 is labeled with the letter “B” in the Figs. for sake of clarity and as shown in FIG. 7 is directed into certain ones of the additional plates 40 that are identified with the letter “B.” The additional plates 40 that receive the second phase 20 are in electrical communication with the second bus bar 36.

The third phase 22 is transferred through the third bus bar 38 and into the third electrode 16. The third bus bar 38 is in electrical communication with the third electrode through direct engagement or through an electrical connection, or through any mechanism allowing such electrical communication. The third phase 22 is labeled with the letter “C” in the Figs. for sake of clarity and as shown in FIG. 7 is directed into certain ones of the additional plates 40 that are identified with the letter “C.” The additional plates 40 that receive the third phase 22 are likewise in electrical communication with the third bus bar 38 in the same or different manners than the third electrode 16.

The phases 18, 20 and 22 supplied to the additional plates 40 are supplied in such a way that they form a repeating pattern in the direction of fluid flow 76 through the electrodes 12, 14, 16 and 40. In the direction of fluid flow 76, the phases 18, 20 and 22 are supplied in the order of “A”, “B”, and “C” and then this pattern repeats itself nine times in the FIG. 7 embodiment. It is to be understood that the repeating of the pattern 9 times is only exemplary and that from 1-4, from 5-8, or up to 100 repeats of the pattern may be present in other arrangements of the system 10.

The pattern is such that the first phase 18 (A) is supplied to an electrode immediately after the third phase 22 (C) and immediately before the second phase 20 (B) in the direction of fluid flow 76. It is to be understood that the pattern of phases 18, 20 and 22 supplied to the electrodes 12, 14, 16 and 40 is only exemplary and that others are possible. For example, two subsequent electrodes supplied with the first phase 18 (A) may be followed by two subsequent electrodes supplied with the second phase 20 (B) followed by a single electrode supplied with the third phase 22 (C). This pattern may repeat itself throughout the entire amount of electrodes, or the pattern may change after some amount of repeating. In further arrangements, a pattern of phases 18, 20 and 22 does not exits and the phases 18, 20 and 22 are randomly supplied to a plurality of electrodes in the system 10. Although described as being in the direction of fluid flow 76, the repeating pattern of phases 18, 20, 22 described may be provided even if there is no fluid flow 76 through the chamber 24, or even if the fluid flow 76 is reversed in direction from that shown in FIG. 7. The system 10 may therefore operate to remove contaminants even if no fluid flow 76 is present, and may employ three or more electrodes 12, 14 and 16 in which at least three phases 18, 20 and 22 are provided to the electrodes 12, 14 and 16.

The chamber 24 may be any type of chamber. The chamber 24 may be an open-top vessel, a closed vessel, or a pressure vessel in accordance with various exemplary embodiments. The electrodes 12, 14 and 16 may be completely housed within a closed vessel, or may be housed partially within and outside of the closed vessel in accordance with various exemplary embodiments. When the chamber 24 has an open top, the fluid 26 can be exposed to atmosphere such that the pressure of the fluid 26, and other components of the system 10, during the electrocoagulation process is at atmospheric pressure. FIG. 8 shows a front view of the system 10 of FIGS. 6 and 7. The side edges of the trapezoidal shaped electrode 12 may be seen to extend beyond the frame 74. The frame 74 may extend outwards to encapsulate the extensions shown in FIG. 8 in some arrangements. The chamber 24 may be a rectangular in cross-sectional shape. In other embodiments, the chamber 24 may have a square shaped cross-section, an oval shaped cross-section, a triangular shaped cross-section, or may be variously shaped. Also, although shown as employing apertures 28, 30, 32 and 42 through which the fluid 26 flows, in other arrangements apertures 28, 20, 32, 42 in some or all of the electrodes 12, 14, 16 and 40 need not be present.

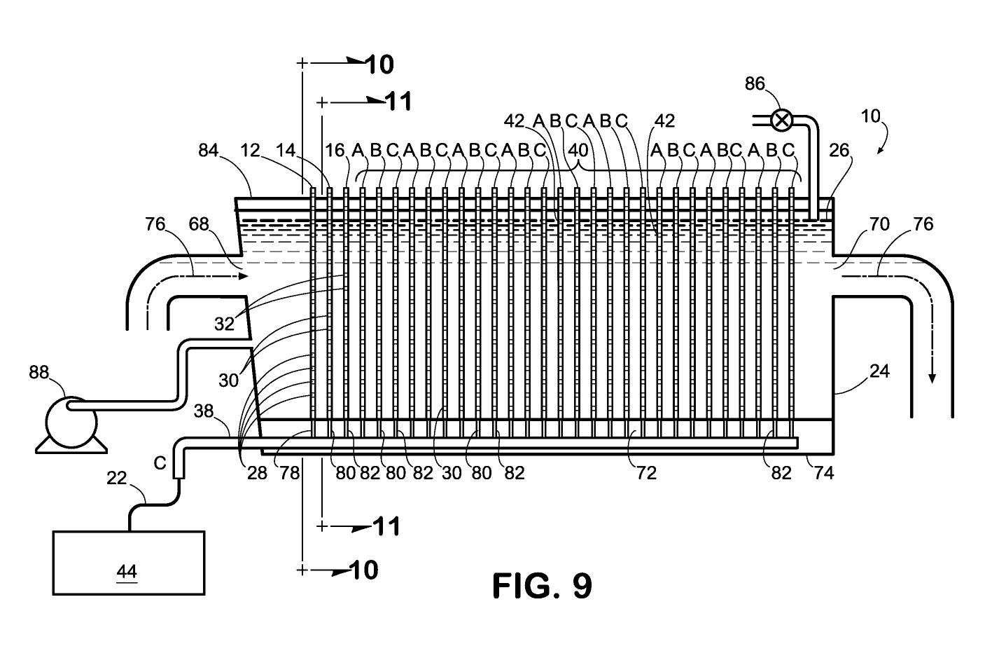

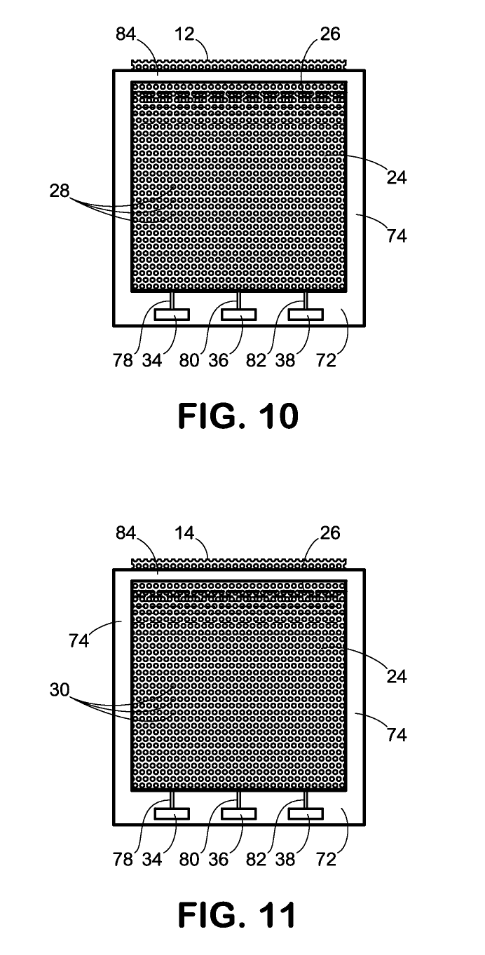

FIGS. 9-11 illustrate an alternative exemplary embodiment of the system 10 that is similar to the one previously discussed with reference to FIGS. 6-8. The electrodes 12, 14, 16 and 40 are arranged in the same “A”, “B”, “C” repeating manner, but there are only 5 repeats of this pattern instead of 10 as previously described. Further, the electrodes 12, 14, 16 and 40 are rectangular in cross-sectional shape and are not trapezoidal. Also, the chamber 24 and fluid 26 are illustrated and an inlet 68 of the chamber 24 is shown into which the fluid 26 is directed. The fluid 26 does not reach the upper end of the electrodes 12, 14, 16 and 40 and flows through the apertures 28, 30, 32 and 42 without passing under or around the electrodes 12, 14, 16 and 40.

In other arrangements, the upper ends of the electrodes 12, 14, 16 and 40 may extend through a top plate 84 of the frame 74 forming the chamber 24. The electrodes 12, 14, 16 may not be in electrical communication with the top plate 84 such that insulators are used, or such that the top plate 84 is not conductive. Alternatively, the electrodes 12, 14 and 16 may be located completely below the top plate 84 and engage the bottom of the top plate 84. Again, the top plate should be non-conductive or insulators should be employed to prevent electrical communication between the electrodes 12, 14, 16 through the top plate 84.

The fluid 26 can be pressurized in the chamber 24 as the chamber with the top plate 84 can be a sealed chamber 24. A pressure device 88, such as a pump, can be used to pressurize the fluid 26 to any desired pressure such as from 20-30 psi, 30-40 psi, or up to 100 psi. A vapor release valve 86 can be located in the chamber 24 and may be in communication with the interior of the chamber 24 through a hole in the top plate 84. Vapor formed in the chamber 24 through the electrocoagulation process may be vented as desired through the vapor release valve 86 to a desired location.

Fluid 26 may rise all the way up and contact the bottom of the top plate 84, or a space may be present between the bottom of the top plate 84 and the top of the fluid level 26. The fluid 26 may not flow over the tops of the electrodes 12, 14, 16 and 40. After traversing through the series of electrodes 12, 14, 16 and 40, the fluid 26 exits an outlet 70 of the chamber 24.

The conduit 72 includes the three bus bars 34, 36 and 38 and they may be separated from the frame 74 and electrically isolated from the frame 74. The first bus bar 34 has an electrical connection 78 through which the first phase 18 passes from the first bus bar 34 to the first electrode 12. The electrical connection 78 may be a bar made of metal, a wire, or other component capable of conducting an electric charge. The first bus bar 34 may run through the conduit 72 past the first electrode 12 and additional electrical connections 78 may extend from the first bus bar 34 to the various additional plates 40 that are to be charged with the first phase 18 (A).

The second bus bar 36 is located between the first bus bar 34 and third bus bar 38 and includes electrical connection 80 that causes the second phase 20 to be passed from the second bus bar 36 to the second electrode 14. The second bus bar 36 may extend along the conduit 72 past the second electrode 14. Additional electrical connections 80 may extend from the second bus bar 36 to the additional electrodes 40 to which the second phase 20 (B) is to be sent.

The third bus bar 38 carries the third phase 22 to the third electrode 16, and an electrical connection 82 from the third bus bar 38 to the third electrode 16 is present to place them in electrical communication with one another. the third phase 22 is shown as coming from the power supply 44 by a wire and into the third bus bar 38 that is likewise attached to the wire. The attachment of the wire to the third bus bar 38 may take place outside of the conduit 72 as the third bus bar 38 (along with the first and second bus bars 34 and 36) may have a portion located outside of the conduit 72. There may be additional electrical components between the power supply 44 and the third bus bar 38 as previously discussed, and it is to be understood that the illustrated arrangement is but one of many that may be employed. Additional electrical connections 82 may be included and can be used to place the third bus bar 38 into electrical communication with the additional plates 40 to which the third phase 22 (C) is to be channeled.

Another feature that can be incorporated into any of the previously described systems 10, or other up until now non-described systems 10, is adjustability of the electrodes 12, 14 and 16 of the three phase AC power. The electrodes 12, 14 and 16 are adjustable in that their spacing from one another can be adjusted by the operator of the system 10. In this regard, the spacing between electrodes 12, 14 and 16 can be at one distance while the system 10 is run, and then modified to another, greater or lesser distance when the system 10 is stopped and then subsequently run at this different distance. The spacing between electrodes 12 and 14 may be the same as that between electodes 14 and 16 and also the same as that between electrode 16 and electrode 12 of the subsequent sequence of electrodes 12, 14 and 16 (if a second repeating set 40 is employed). Alternatively, the spacing between electrodes 12 and 14 may be different than that of electrodes 14 and 16, which may likewise be the same or different than that of electrodes 16 and 12 of the subsequent set 40.

Although described as being used with three phase AC systems 10, the adjustable electrode feature may be incorporated into other electrocoagulation systems that do not employ three phase AC power. In this regard, the distance between electrode 12 and 14 can be adjusted, along with the adjustability of the distance between subsequent sets of electrodes 12 and 14 in the system.

Adjustment of the distances between electrodes 12, 14 (and 16 in three phase AC systems 10) allows for greater control of current density through varied voltage in different types of conductive fluids 26. However, the distance between electrodes 12, 14 (and 16 in three phase AC systems 10) may be adjusted for other reasons in other exemplary embodiments.

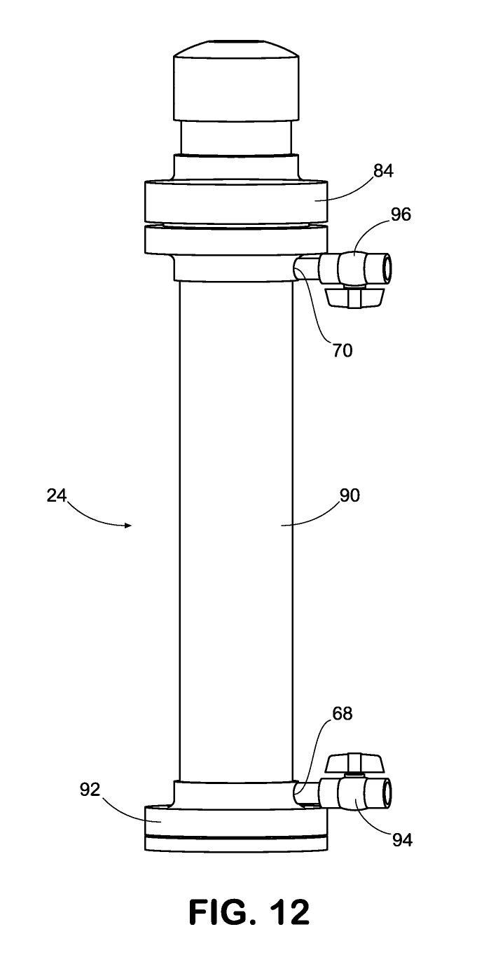

A system 10 that includes a chamber 24 that incorporates adjustable electrodes 12, 14 and 16 is illustrated in FIG. 12. The chamber 24 extends in a vertical direction in which a bottom plate 92 defines the bottom of the chamber 24 and an oppositely disposed top plate 84 defines the top of the chamber 24. A side wall 90 extends between the bottom plate 92 and the top plate 84 and is cylindrical in shape. The chamber 24 defined by the plates 84, 90 and 92 can be sealed and pressurized to a pressure greater than or less than atmospheric pressure as desired. For example, the fluid 26 in the chamber 24 may be at a pressure from 0-100 psi in accordance with certain arrangements of the system 10. The fluid 26 may enter the chamber 24 through an inlet 68. A valve 94 can be opened and closed in order to allow fluid 26 to enter chamber 24, and to prevent fluid 26 from entering chamber 24. The fluid 26 may flow through the interior of chamber 24 along the length of the side wall 90 and exit the chamber 24 via an outlet 70. A valve 96 can be manually actuated by the user in order to permit the fluid 26 to flow out of the outlet 70 and the chamber 24, and to prevent the fluid 26 from exiting the outlet 70 and chamber 24.

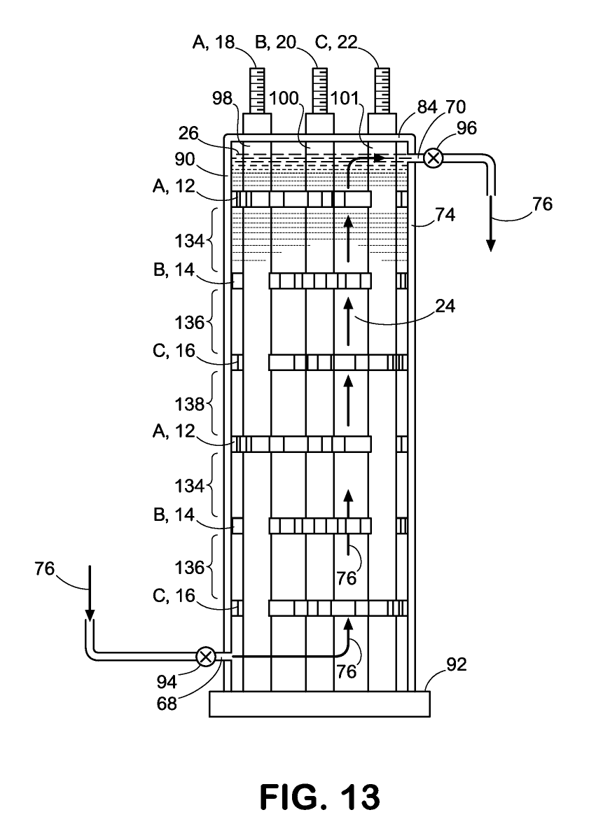

FIG. 13 shows a chamber 24 similar to that previously described with respect to FIG. 12 but with a side wall 90 that is transparent in order to allow the interior of chamber 24 to be viewed. Fluid 26 entering the chamber 24 through inlet 68 flows through the various apertures 28, 30 and 32 of the electrodes 12, 14 and 16 and electrocoagulation may take place as previously described. The electrodes 12, 14 and 16 are configured as plates in the embodiment illustrated. The fluid 26 may flow through the top plate 12 and exit chamber 24 via the outlet 70.

The first phase 18 is transferred through a first terminal 128 located above the top plate 84 and outside of the chamber 24. The first phase 18 flows through the first terminal 128 and into the various first electrodes 12. The second phase 20 is transferred through a second terminal 130 likewise located outside of chamber 24 and into the various second electrodes 14. Finally, the third phase 22 flows through a third terminal 132 located outside of chamber 24 and above plate 84 and into the one or more third electrodes 16 inside of the chamber 24. A first insulating sleeve 98 prevents the first phase 18 from arcing into either one of the electrodes 14 or 16 and keeps the first phase 18 isolated until extending through the first electrodes 12. In a similar manner, the second insulating sleeve 100 electrically isolates the second phase 20 and limits its exposure to the second electrode 14, and the third insulating sleeve 101 electrically isolates the third phase 22 to flowing through the third electrodes 16 and not into the first or second electrodes 12, 14. The various plates 12, 14 and 16 are configured geometrically to allow the insulating sleeves 98, 100 and 101 to extend therethrough as necessary. The insulating sleeves 98, 100 and 101 may extend all the way from the top plate 84 to the bottom plate 92 and thus may extend along the entire height of the chamber 24 and the side wall 90. The insulating sleeves 98, 100 and 101 may be made of any material or materials capable of electrical insulation of the phases 18, 20, 22 of the three phase AC power.

The first distance 134 is shown as extending between the first and second plates 12, 14. Second distance 136 extends between the second plate 14 and third plate 16. Also, third distance 138 extends between the third plate 16 and the first plate 12 of the next subsequent set of plates 12, 14, 16 in sequence. Distances 134, 136 and 138 may be the same or different from one another. The distances 134, 136 and 138 extend along the longitudinal axis of the chamber 24 which is longer than the lateral axis of chamber 24. Alternatively, the distances 134, 136 and 138 may all be different than one another. The distances 134, 136 and 138 may be adjusted by the user as desired.

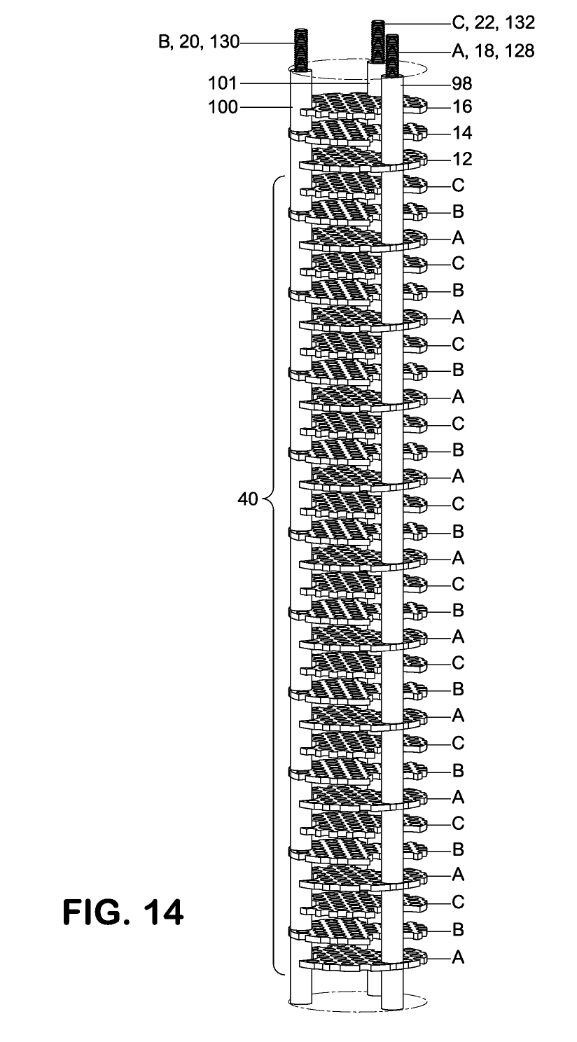

FIG. 14 is a view similar to FIG. 13 but only shows the plate stack 12, 14, 16 without the presence of the chamber 24. Several additional electrodes 12, 14 and 16 are incorporated into the stack of additional electrodes 40 along almost the entire lengths of the insulating sleeves 98, 100 and 101. Any number of additional sets of electrodes 12, 14 and 16 can be included into the additional electrodes 40. The distances of all of the electrodes 12, 14 and 16 illustrated may be adjustable. Alternatively, the system 10 can be set up so that the distances between some of the electrodes 12, 14 and 16 are adjustable, and so that the distances between the remaining electrodes 12, 14 and 16 are not adjustable.

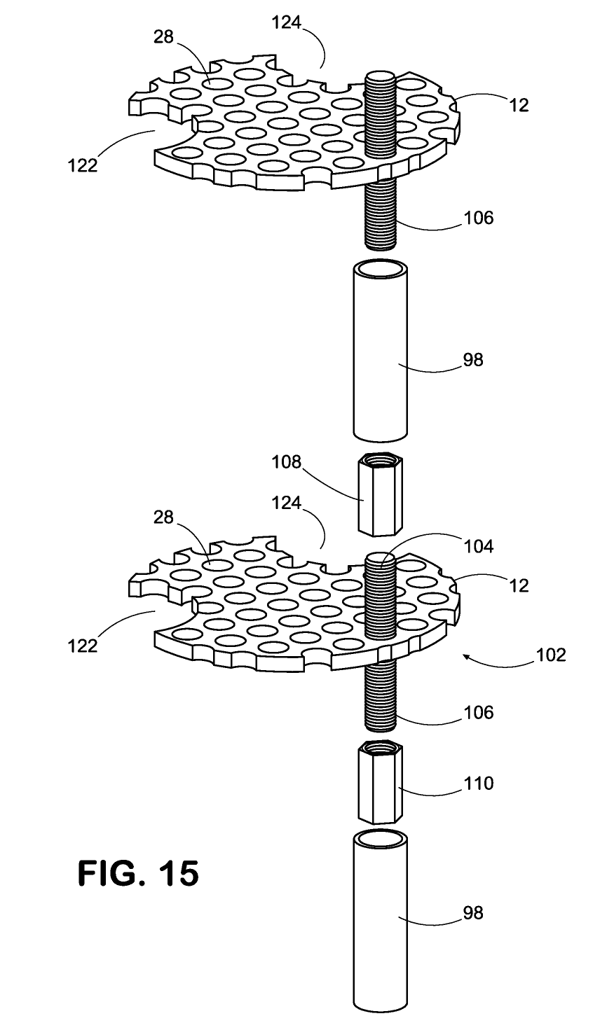

The distances between the electrodes 12, 14 and 16 can be adjusted by way of an adjustment mechanism 102 that is shown in FIG. 15. Since the sets of electrodes 12, 14 and 16 are electrically isolated from one another with respect to the various phases 18, 20, 22 that are input into the electrodes 12, 14 and 16, the adjustment mechanism 102 is limited to adjustment of the distances effecting the various electrodes 12 in the stack of additional electrodes 40. Similar adjustment mechanisms 102 can be incorporated into the path of the second phase 20 of the second electrodes 14, and into the path of the third phase 22 of the third electrodes 16. Adjustment of the distances between the electrodes 12, along with corresponding adjustment of the distances between the second electrodes 14 and the third electrodes 16, will in turn allow one to adjust the distances 134, 136 and 138 previously discussed.

The adjustment mechanism 102 includes a first post 104 and a second post 106. The posts 104 and 106 may be integrally formed with one another or may be separate pieces. The first post 104 extends from the top of the first plate 12, and the second post 106 extends in the opposite direction from the bottom of the first plate 12. The first post 104 and the second post 106 both have external threading thereon. The first post 104 and second post 106 may be fixed relative to the first plate 12 so that they do not move or rotate relative to the first plate 12 and their positions with respect to the first plate 12 are fixed.

A first adjusting sleeve 108 has internal threading that engages the external threading of the first post 104. A second adjusting sleeve 110 has internal threading that engages the external threading of the second post 106. All of the threading of the first post 104, second post 106, first adjusting sleeve 108 and second adjusting sleeve 110 may be in the same direction such that it is all right handed threading or all left handed threading. The first and second adjusting sleeves 108 and 110 function as coupling nuts in this arrangement. A subsequent first plate 12 likewise has a second post 106 with similar external threading that engages the internal threading of the first adjusting sleeve 108 that is engaged with the first post 104 of the first described first plate 12. Relative rotation of the first post 104, and second post 106 that both engage the first adjusting sleeve 108 causes a change in the distance between the two first plates 12 shown in FIG. 15. The first phase 18 can travel through the posts 104 and 106 and adjusting sleeves 108 and 110 because all of these parts are electrically conductive. The second adjusting sleeve 110 engages a first post 104 (not shown) of a successive first plate 12 (not shown) in a similar manner, and a repeat of this information is not needed.

Another embodiment of the adjustment mechanism 102 is possible in which the first adjusting sleeve 108 has half of its internal threading as left handed threading, and half of its internal threading as right handed threading. The first post 104 may have left handed external threading, and the second post 106 may have right handed external threading thereon. The first adjusting sleeve 108 in this arrangement may function as a tensioning nut, and relative rotation may cause movement along the threads and adjustment of the distance between the two subsequent first electrodes 12.

The first insulating sleeve 98 is disposed over the various first posts 104, second posts 106, first adjusting sleeves 108 and second adjusting sleeves 110. The first insulating sleeve 98 is made of a plurality of sections along the entire stack of plates 12. The first insulating sleeve 98 may be made of a flexible material to allow one to effect adjustment of the adjustment mechanism 102 without having to remove the first insulating sleeve 98. Alternatively, one may remove the first insulating sleeve 98 to access the first and second posts 104 and 106 and the first adjusting sleeve 108 attached to them.

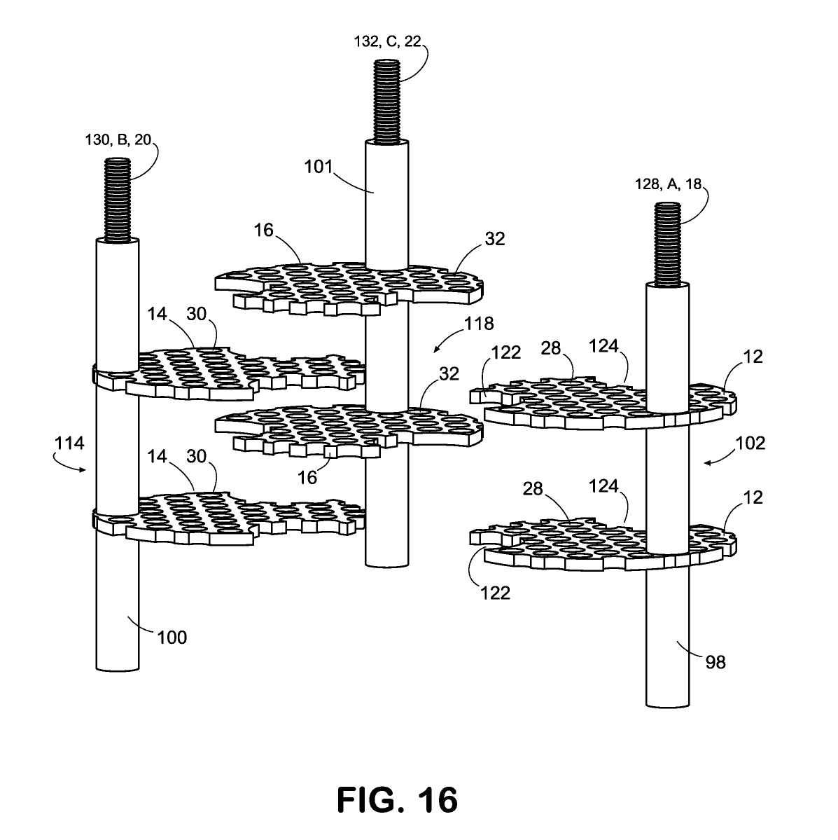

FIG. 16 shows two of the assembled stack of first plates 12 in relation to two of the assembled stack of second plates 14 and third plates 16. Additional plates 12, 14 and 16 could be present, but for clarity only two of each of the plates 12, 14 and 16 are shown. The adjustment mechanism 102 allows the distance between the two plates 12 to be adjusted. A second adjustment mechanism 114 affords the user the ability to adjust the distance between a second plate 14 and a subsequent second plate 14. The second adjustment mechanism 114 maybe provided in a manner similar to the first adjustment mechanism 102 described and a repeat of this information is not necessary. A third adjustment mechanism 118 is present to allow the user to adjust the distance between a third plate 16 and another third plate 16 subsequent to this third plate 16. Again, the third adjustment mechanism 118 may be arranged in a manner similar to the first adjustment mechanism 102 and a repeat of this information is not necessary.

The geometry of the various plates 12, 14 and 16 and their corresponding adjustment mechanisms 102, 114 and 118 is such that they are electrically isolated from one another and adjustable with respect to one another. The various adjustment mechanisms 102, 114 and 118 maybe be actuated by the user by accessing the interior of the chamber 24 when the system 10 is not performing electrocoagulation. Actuation causes the plates 12, 14 and 16 to be adjusted so that in turn the distances 134, 136 and 138 between successive plates in the plate stack can likewise be adjusted. It is therefore the case that distances between successive plates in sequence in the plate stack are adjusted through the adjustment of successive plates that share the same phase 18, 20 or 22.

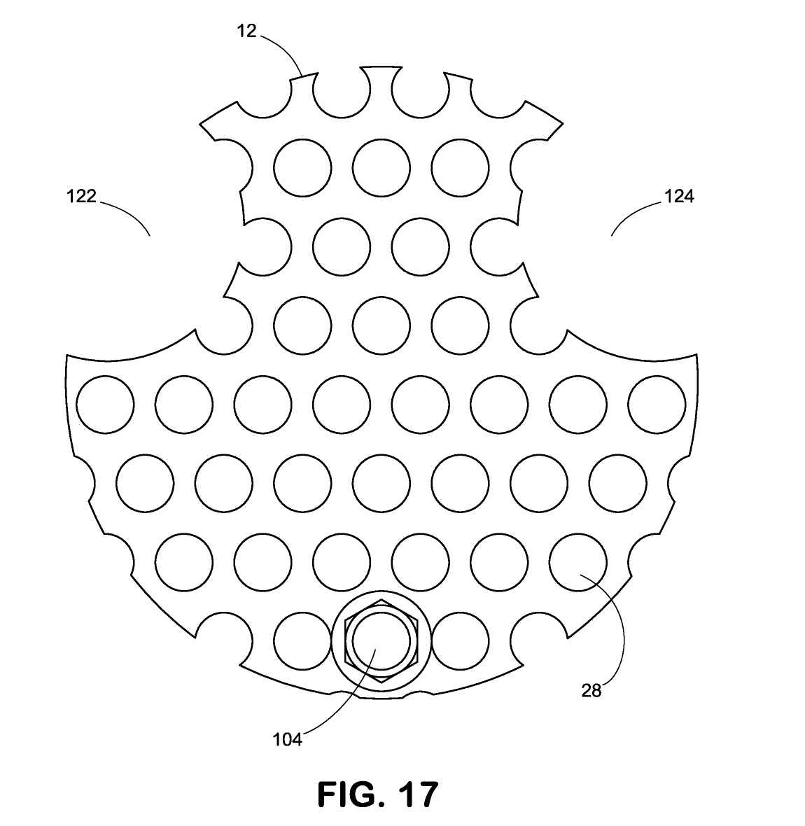

A top view of the first plate 12 is shown in FIG. 17. The first post 104 is shown attached to the top of the first plate 12 and is circular in cross-sectional shape. The first plate 12 has a generally circular outer circumference and the outer extreme edge of the first plate 12 engages the side wall 90. Fluid 26 may not flow past the outer circumference of the first plate 12 so as to flow between this outer edge and the side wall 90. A series of apertures 28 are disposed completely through the first plate 12 to allow the fluid 26 to flow through the first plate 12. The first plate 12 also includes a first cut out 122 and a second cut out 124 that extend inwards from the outermost circumference of the first plate 12. The first and second cut outs 122 and 124 may be semi-circular in shape. The first and second cut outs 122 and 124 allow the components of the second and third electrodes 14 and 16 to extend through the first plate 12 so that the second and third phases 20 and 22 may extend through the first plate 12 without being transferred into the first plate 12. Fluid 26 may flow through the first and second cut outs 122 and 124. In other embodiments, fluid 26 does not flow through the first and second cut outs 122 and 124. The second and third plates 14 and 16 may likewise include cut outs 122 and 124 to in turn allow other components to pass through the second and third plates 14 and 16.

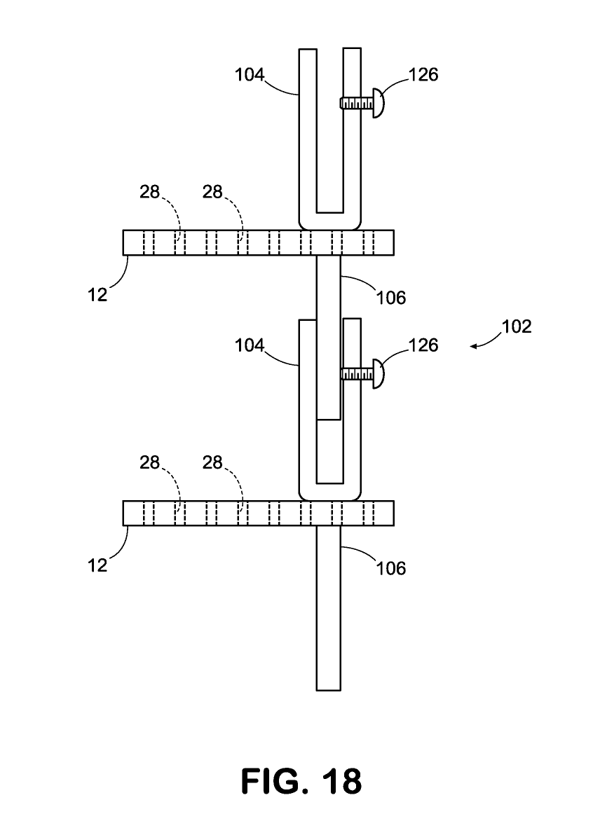

An alternative manner of causing the plates 12, 14 and 16 to be adjustable with respect to one another is illustrated in FIG. 18. The adjustment mechanism 102 used in connection with two sequential first plates 12 is illustrated. The first post 104 is not threaded but does have a cavity therein that is accessible through an opening on the top of the first post 104. The second post 106 of the successive first plate 12 is a solid post and does not include any threading. The second post 106 can be inserted into the cavity of the first post 104 and moved to a desired distance so that the distance between the two plates 12 is likewise set to a desired distance. A set screw 126 may extend through a wall of the first post 104 and may engage the second post 106. Tightening down of the set screw 126 causes the relative position of the first and second posts 104 and 106 to be fixed to in turn cause the relative position of the successive first plates 12 to be fixed. The set screw 126 engages the second post 106 and fixes its position within the cavity of the first post 104. The set screw 126 has external threading that engages complimentary internal threading in the hole through a side of the first post 104. The second and third adjustment mechanisms 114 and 118 can be arranged in a similar manner to allow for adjustment of the second and third plate 14 and 16. The distances 134, 136 and 138 may be adjusted as desired through actuation of the adjustment mechanism 102, 114 and 118.

Although not illustrated, another arrangement of the adjustment mechanism 102 may be provided such that a threaded post 104 is provided and so that the first plate 12 engages the threaded post. The first plate 12 can be rotated relative to the threaded post 104 to move it along the length of the threaded post 104. In this manner, the distances between the various, successive first plates 12 can be adjusted. The other plates 14 and 16 can be arranged in a similar manner to cause the entire plate stack to be arranged so that the distances between the plates 12, 14 and 16 can be adjusted. It is to be understood that there are various ways possible of adjusting the distances 134, 136 and 138 and that the disclosed manners represent only certain exemplary embodiments.

The adjustment mechanisms 102, 114 and 118 can be used in embodiments that have only a single electrode 12, 14 or 16 and not multiple electrodes 12, 14 and 16. In this regard, the adjustment mechanisms 1-2, 114 and 118 can simply adjust the distance of the single electrodes 12, 14 and 16 within the chamber 24 such that their distance is not adjusted with respect to the second electrodes 12, 14 and 16. The adjustability effect is the same such that the distances 134, 136 and 138 may be adjusted. In these embodiments, the adjusting mechanisms 102, 114 and 118 may be attached to a portion of the chamber 24 or some post or other item rigidly fixed to the chamber 24.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A system for electrocoagulation, comprising:
a first electrode;
a second electrode;
a third electrode; and
three phase AC power, wherein a first phase of the three phase AC power is supplied to the first electrode, wherein a second phase of the three phase AC power is supplied to the second electrode, and wherein a third phase of the three phase AC power is supplied to the third electrode.

2. The system for electrocoagulation as set forth in claim 1, wherein the three phase AC power has variable voltage.

3. The system for electrocoagulation as set forth in claim 1, wherein the three phase AC power has variable frequency.

4. The system for electrocoagulation as set forth in claim 1, wherein the three phase AC power has variable voltage and variable frequency such that the first phase supplied to the first electrode has variable voltage and variable frequency, and such that the second phase supplied to the second electrode has variable voltage and variable frequency, and such that the third phase supplied to the third electrode has variable voltage and variable frequency.

5. The system for electrocoagulation as set forth in claim 1, further comprising a fluid that is passed over the first electrode, the second electrode, and the third electrode.

6. The system for electrocoagulation as set forth in claim 1, further comprising a chamber into which the first electrode, the second electrode, and the third electrode are located, wherein fluid enters the chamber and exits the chamber, wherein the first electrode is a plate that has a plurality of apertures therethrough, wherein the second electrode is a plate that has a plurality of apertures therethrough, wherein the third electrode is a plate that has a plurality of apertures therethrough, wherein the fluid flows through the apertures of the first electrode and then subsequently through the apertures of the second electrode and then subsequently through the apertures of the third electrode before exiting the chamber.

7. The system for electrocoagulation as set forth in claim 6, further comprising:
a first bus bar through which the first phase of the three phase AC power is transferred into the first electrode;
a second bus bar through which the second phase of the three phase AC power is transferred into the second electrode;
a third bus bar through which the third phase of the three phase AC power is transferred into the third electrode; and
a plurality of additional electrodes that are plates that have a plurality of apertures therethrough, wherein the fluid flows out of the apertures of the third electrode and then subsequently through the apertures of the additional electrodes before exiting the chamber, wherein the first bus bar transfers the first phase of the three phase AC power to some of the additional electrodes, wherein the second bus bar transfers the second phase of the three phase AC power to some of the additional electrodes that do not receive the first phase of the three phase AC power, wherein the third bus bar transfers the third phase of the three phase AC power to the remainder of the additional electrodes that do not receive the first phase of the three phase AC power and that do not receive the second phase of the three phase AC power.

8. The system for electrocoagulation as set forth in claim 1, further comprising:
a variable frequency drive into which electrical power of 460 volts three phase AC power at 60 hertz that becomes the three phase AC power is input, wherein the electrical power exits the variable frequency drive as 460 volts three phase AC power that is adjustable from 0-60 hertz;
a transformer into which the electrical power exiting the variable frequency drive is input, wherein the electrical power exits the transformer as 208 volt three phase AC power adjustable from 0-60 hertz;
a first variable transformer that receives the first phase exiting the transformer, wherein the first phase exits the first variable transformer as adjustable 0-120 volt AC power adjustable from 0-60 hertz;
a second variable transformer that receives the second phase exiting the transformer, wherein the second phase exits the second variable transformer as adjustable 0-120 volt AC power adjustable from 0-60 hertz;
a third variable transformer that receives the third phase exiting the transformer, wherein the third phase exits the third variable transformer as adjustable 0-120 volt AC power adjustable from 0-60 hertz;
a 5:1 first step down transformer that receives the first phase from the first variable transformer, wherein the first phase exits the 5:1 first step down transformer as adjustable 0-20 volt AC power adjustable from 0-60 hertz and is supplied to the first electrode;
a 5:1 second step down transformer that receives the second phase from the second variable transformer, wherein the second phase exits the 5:1 second step down transformer as adjustable 0-20 volt AC power adjustable from 0-60 hertz and is supplied to the second electrode; and
a 5:1 third step down transformer that receives the third phase from the third variable transformer, wherein the third phase exits the 5:1 third step down transformer as adjustable 0-20 volt AC power adjustable from 0-60 hertz and is supplied to the third electrode.

9. The system for electrocoagulation as set forth in claim 1, further comprising a variable frequency drive that causes frequency of the three phase AC power to be adjustable and that causes voltage of the three phase AC power to be adjustable, wherein the voltage of the three phase AC power is adjustable from 0-460 volts and the frequency is adjustable from 0-420 hertz.

10. The system for electrocoagulation as set forth in claim 1, wherein the three phase AC power has variable voltage and variable frequency.

11. The system for electrocoagulation as set forth in claim 1, further comprising a chamber into which the first electrode, the second electrode, and the third electrode are located, wherein fluid enters the chamber and exits the chamber, wherein the chamber is pressurized to a pressure greater than atmospheric pressure.

12. A system for electrocoagulation, comprising:
a plurality of electrodes, wherein a first electrode of the plurality of electrodes is a plate that has a plurality of apertures therethrough, wherein a second electrode of the plurality of electrodes is a plate that has a plurality of apertures therethrough;
a chamber into which the plurality of electrodes are located, wherein fluid is located inside of the chamber and flows through the apertures of the first electrode and then subsequently through the apertures of the second electrode; and
three phase AC power that is supplied to the plurality of electrodes.

13. The electrocoagulation system as set forth in claim 12, wherein a third electrode of the plurality of electrodes is a plate that has a plurality of apertures therethrough, wherein the fluid flows through the apertures of the second electrode and then subsequently through the apertures of the third electrode;
wherein a first phase of the three phase AC power is supplied to the first electrode, wherein a second phase of the three phase AC power is supplied to the second electrode, and wherein a third phase of the three phase AC power is supplied to the third electrode.

14. The electrocoagulation system as set forth in claim 12, wherein the three phase AC power has variable voltage.

15. The electrocoagulation system as set forth in claim 12, wherein the three phase AC power has variable frequency.

16. The electrocoagulation system as set forth in claim 12, wherein the three phase AC power has variable voltage and variable frequency.

17. An electrocoagulation system, comprising:
a first electrode;
a second electrode;
a chamber;
fluid disposed within the chamber, wherein the first and second electrodes are in the fluid;
an adjustment mechanism, wherein a distance between the first electrode and the second electrode is adjustable by the adjustment mechanism.

18. The electrocoagulation system as set forth in claim 17, wherein the first electrode is a plate and wherein the second electrode is a plate, wherein the chamber is a pressurized chamber, and further comprising:
a third electrode that is a plate that is in the fluid;
a second adjustment mechanism that engages the second electrode and adjusts the location of the second electrode relative to the chamber;
a third adjustment mechanism that engages the third electrode and adjusts the location of the third electrode relative to the chamber;
three phase AC power, wherein a first phase of the three phase AC power is supplied to the first electrode, wherein a second phase of the three phase AC power is supplied to the second electrode, and wherein a third phase of the three phase AC power is supplied to the third electrode;
wherein a distance between the first electrode and the second electrode, and a distance between the second electrode and the third electrode are adjustable by adjusting one or more of the first, second, and third adjustment mechanisms.

19. The electrocoagulation system as set forth in claim 17, wherein the first adjustment mechanism has a first post and a second post that extend from the first electrode, wherein the positions of the first post and the second post are fixed relative to the first electrode, wherein both the first post and the second post are threaded, wherein the first adjustment mechanism has a first adjusting sleeve that is threaded and that engages the threading of the first post, wherein the first adjustment mechanism has a second adjusting sleeve that is threaded and that engages the threading of the second post.

20. The electrocoagulation system as set forth in claim 17, wherein the first electrode is a plate that has a plurality of apertures that extend completely through the plate, wherein the fluid flows through the apertures, wherein the plate has a first cut out and a second cut out located at an outer perimeter of the plate, wherein the first and second cut outs are semi-circular in shape.
